(19) United States
(12) Patent Application Publication
(10) Pub. No.: US 2026/0153125 A1
(43) Pub. Date: Jun. 4, 2026

(54) RACK BUSH

(71) Applicant: HYUNDAI MOBIS CO., LTD., Seoul (KR)

(72) Inventor: Je Won KIM, Yongin-si (KR)

(73) Assignee: HYUNDAI MOBIS CO., LTD., Seoul (KR)

(21) Appl. No.: 19/247,754

(22) Filed: Jun. 24, 2025

(30) Foreign Application Priority Data
Dec. 4, 2024 (KR) 10-2024-0178463

(51) Int. Cl. F16C 33/20; F16C 17/02

(52) U.S. Cl. CPC F16C 33/20; F16C 17/02; F16C 2361/61

(57) ABSTRACT

Disclosed is a rack bush including: a mounting part mounted to surround an inner surface of a rack housing; a sliding part formed to surround an outer surface of a rack bar and spaced apart from the mounting part; and an elastic rib connected between the mounting part and the sliding part and configured to be elastically deformed to distribute and absorb a force transmitted from the rack bar to the sliding part.

### CROSS REFERENCE TO RELATED APPLICATION

The present application claims priority of Korean Patent Application No. 10-2024-0178463 filed on Dec. 4, 2024, the entire contents of which is incorporated herein for all purposes by this reference.

### BACKGROUND OF THE DISCLOSURE

### Field of the Disclosure

The present disclosure relates to a rack bush, which simplifies a rack bush manufacturing process by replacing an O-ring with a rib-and-slot structure formed in the rack bush.

### Description of the Related Art

A rack bar is built into a rack housing of a steering gear, and a rack bush and a support yoke serve to support the rack bar on the left and right sides of the rack bar.

A conventional rack bush is of a flexible type and achieves elasticity and resilience through an O-ring surrounding the rack bush from the outside. Accordingly, when the rack bar moves, the rack bush undergoes repeated deformation and restoration, thereby enabling smooth movement of the rack bar.

However, the O-ring needs to be assembled separately onto an outer peripheral surface of the rack bush, and thus an additional assembly process is required, thereby increasing manufacturing costs.

Furthermore, when a gap occurs between the rack bush and the rack housing due to a thickness dimensional tolerance of the rack bush, reducing the gap through tuning is challenging, thereby causing a clearance and friction issue.

The matters described above as a background art are provided solely to facilitate a better understanding of the background of the present disclosure and should not be construed as an admission that they constitute a related art already known to those skilled in the art.

### SUMMARY OF THE DISCLOSURE

The present disclosure is proposed to provide a rack bush, which simplifies a rack bush manufacturing process by replacing an O-ring with a rib-and-slot structure formed in the rack bush.

Technical objectives of the present disclosure are not limited to the technical objectives mentioned above, and other technical objectives not mentioned above will be clearly understood by those skilled in the art from the following description.

A rack bush according to the present disclosure may include: a mounting part mounted to surround an inner surface of a rack housing; a sliding part formed to surround an outer surface of a rack bar and spaced apart from the mounting part; and an elastic rib connected between the mounting part and the sliding part and configured to be elastically deformed to distribute and absorb a force transmitted from the rack bar to the sliding part.

The mounting part and sliding part may be divided along a circumferential direction, and the elastic rib may be connected between each of resulting divided mounting portions and sliding portions, such that the mounting portions and the sliding portions may be configured to be continuously joined by the elastic rib without interruption.

One mounting portion and one sliding portion may face a plurality of sliding portions and mounting portions, respectively, in a divided configuration, and the elastic rib may be connected between an end of the mounting portion and an end of the sliding portion facing the end of the mounting portion.

The mounting part and the sliding part may be formed on a concentric circle and equally divided into a plurality of portions; and the elastic ribs may be disposed at equal or unequal angular intervals around an axis of the concentric circle.

A groove may be formed along a circumferential direction on an inner surface of the sliding portion.

The groove may be formed to extend to ends of the sliding portion in a circumferential direction.

An inner slot having an axially cut shape may be formed between the sliding portion and an adjacent sliding portion adjacent to the sliding portion.

An inner auxiliary slot having an axially cut shape may be partially formed in a middle portion of the sliding portion.

An outer slot having an axially cut shape may be formed between the mounting portion and an adjacent mounting portion adjacent to the mounting portion.

An outer auxiliary slot having an axially cut shape may be partially formed in a middle portion of the mounting portion.

An assembly protrusion may be formed to protrude from an outer surface of the mounting portion.

A chamfer may be formed at an axial end of the assembly protrusion.

The elastic rib may be formed to have a curved cross-sectional shape and to be bendable.

The present disclosure provides a structure that has an elastic and flexible deformation function through the elasticity of the elastic rib and the slot structure, and stably supports general movement of the rack bar while effectively absorbing bending and twisting of the rack bar when an external force is applied, thereby enabling smooth operation of the rack bar.

Furthermore, since the rack bush is elastically deformed by the elastic rib and the slot structure, additional assembly of an O-ring or the like required for flexible deformation of the rack bush is unnecessary. Accordingly, the manufacturing process of the rack bush is simplified, thereby reducing the cost of the rack bush.

The effects which may be achieved in the present disclosure are not limited to the effects mentioned above, and other effects not mentioned above will be clearly appreciated by those skilled in the art from the following description.

### BRIEF DESCRIPTION OF THE DRAWINGS

FIG. 1 is a view illustrating a rack bush mounted on a steering system.

FIG. 2 is a view illustrating a rack bush according to an embodiment of the present disclosure.

FIG. 3 is a view illustrating a rack bush according to an embodiment of the present disclosure, when viewed from an axial direction.

FIG. 4 is an enlarged view illustrating a portion of FIG. 3.

FIG. 5 is a side view illustrating a rack bush according to an embodiment of the present disclosure.

### DETAILED DESCRIPTION OF THE DISCLOSURE

In describing embodiments disclosed herein, when a detailed description of a known related art is determined to obscure the gist of the embodiments disclosed herein, the detailed description thereof will be omitted herein. In addition, the accompanying drawings are merely for easy understanding of the embodiments disclosed herein, and the technical spirit disclosed herein is not limited by the accompanying drawings, but it should be understood to include all modifications, equivalents, and substitutes included in the spirit and scope of the present disclosure.

Terms including ordinal numbers such as first, second, and the like used herein may be used to describe various components, but the various components are not limited by these terms. The terms are used only for the purpose of distinguishing one component from another component.

Unless the context clearly dictates otherwise, the singular form includes the plural form.

The terms “comprising,” “having,” or the like as used herein are used to specify that a feature, a number, a step, an operation, a component, an element, or a combination thereof described herein is present, and they do not preclude the presence or addition of one or more other features, numbers, steps, operations, components, elements, or combinations thereof.

As used in the following description, suffixes “module” and “part” for a component are used or interchangeably used solely for ease of preparation of the specification and do not have different meanings, and each of them does not function by itself.

When a component is referred to as being “connected” or “coupled” to another component, the component may be directly connected or coupled to another component, but it should be understood that still another component may be present between the component and another component. Conversely, when a component is referred to as being “directly connected” or “directly coupled” to another, it should be understood that still another component may not be present between the component and another component.

In addition, a unit or control unit included in names is merely a term widely used in the naming of a controller that controls the certain function of a vehicle, but does not mean a generic function unit.

A controller may include a communication device for communicating with other control units or sensors to control a responsible function, a memory for storing an operating system, a logic command, and input/output information, and one or more processors for executing determination, calculation, and decision which are necessary for controlling the responsible function.

Any number of components or a variety of components in any of the configurations described herein may be included in the disclosure described herein. The components may include any combination of the features described herein, and may be arranged in any of the various configurations described herein. The concepts associated with the structure and arrangement of components, as well as their use and operation, of the present disclosure may be applied not only to certain embodiments discussed herein but also to any number and combination of embodiments. Embodiments including those having various features of various arrangements are described below with reference to the drawings.

Hereinafter, embodiments disclosed herein will be described in detail with reference to the drawings. The same reference numerals are given to the same or similar components regardless of reference numerals, and a repetitive description thereof will be omitted.

The present disclosure is configured to include a mounting part 100 mounted to surround an inner surface of a rack housing 20; a sliding part 200 formed to surround an outer surface of a rack bar 30 and spaced apart from the mounting part 100; and an elastic rib 300 connected between the mounting part 100 and the sliding part 200 and configured to be elastically deformed to distribute and absorb a force transmitted from the rack bar 30 to the sliding part 200.

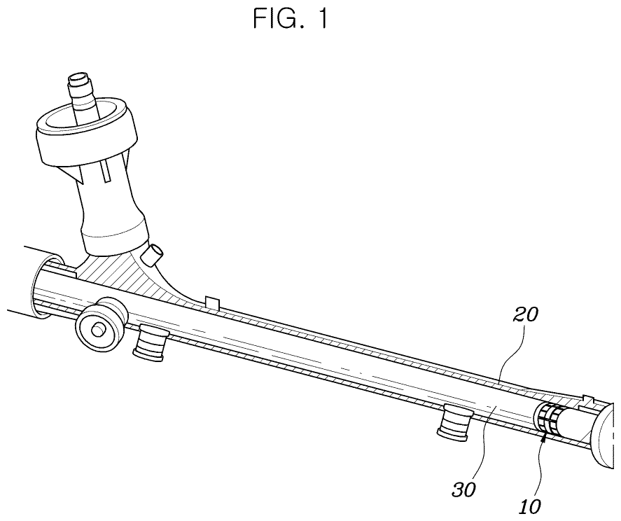

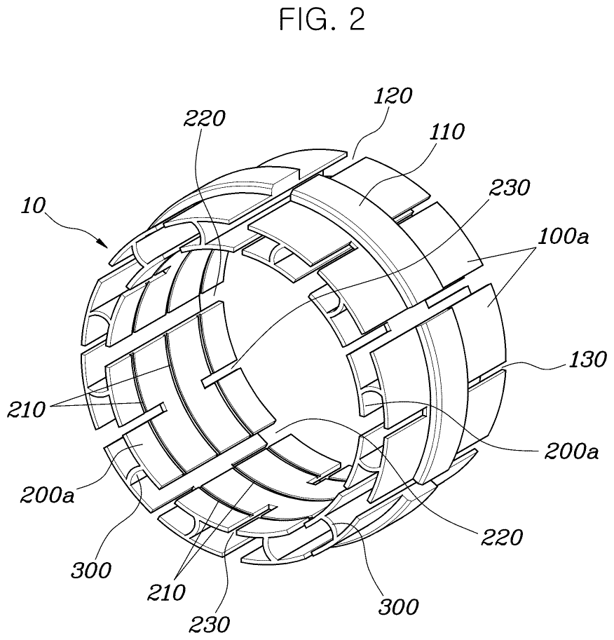

Referring to FIGS. 1 and 2, a rack bush 10 is installed between the rack bars 30 of the rack housing 20, and the rack bush 10 is configured to include the mounting part 100, the sliding part 200, and the elastic rib 300.

The mounting part 100 is formed in a ring shape, such that an outer peripheral surface of the mounting part 100 is mounted on an inner peripheral surface of the rack housing 20.

The sliding part 200 is formed in a ring shape having an outer diameter smaller than an inner diameter of the mounting part 100, and is provided to be spaced apart a predetermined distance from the mounting part 100 in an inner radial direction of the mounting part 100; and an inner peripheral surface of the sliding part 200 comes into contact with an outer peripheral surface of the rack bar 30 to guide a sliding movement of the rack bar 30.

The elastic rib 300 is connected between the mounting part 100 and the sliding part 200 in a space formed between the mounting part 100 and the sliding part 200. The elastic rib 300 is formed integrally with the mounting part 100 and the sliding part 200.

In particular, the elastic rib 300 is formed of a material having a predetermined level of elasticity, such that when a force is applied from the rack bar 30 to the sliding part 200, the elastic rib 300 is elastically deformed to distribute and absorb the force applied to the sliding part 200.

Accordingly, the rack bar 30 is stably held by the elastic force of the elastic rib 300; and when an external force is applied, the shape of the elastic rib 300 is deformed to support the rack bar 30, thereby enabling smooth movement of the rack bar 30.

In particular, in the present disclosure, since the elastic rib 300 connected between the mounting part 100 and the sliding part 200 is elastically deformed, additional assembly of an O-ring or the like required for elastic deformation of the rack bush 10 is unnecessary. Accordingly, the manufacturing process of the rack bush 10 may be simplified, thereby reducing the cost of the rack bush 10.

In addition, in the present disclosure, the mounting part 100 and the sliding part 200 are divided along a circumferential direction; and the elastic rib 300 is connected between each of resulting divided mounting portions 100a and sliding portions 200a, such that the mounting portions 100a and the sliding portions 200a are configured to be continuously joined by the elastic rib 300 without interruption.

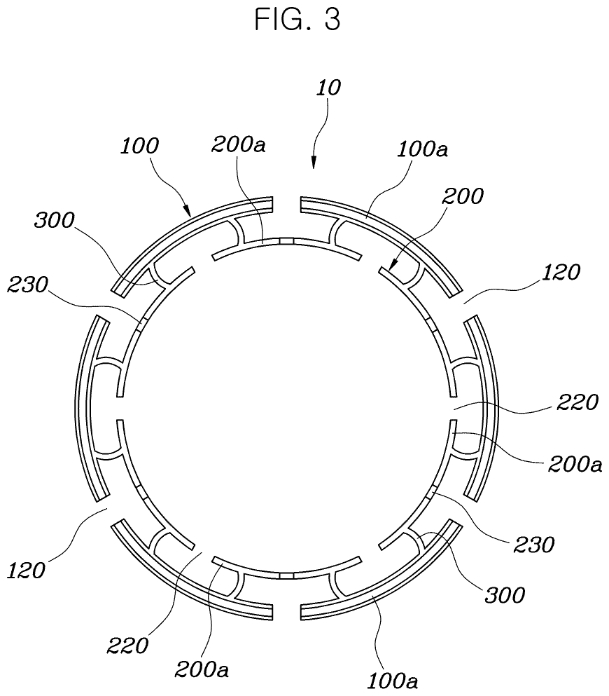

Referring to FIGS. 2 and 3, the mounting part 100 is divided into multiple mounting portions 100a along a circumferential direction of the mounting part 100 around the axis of the rack bush 10; and thus the mounting portions 100a are provided along the circumferential direction, and the mounting portions 100a are formed to have an arc-shaped cross-section.

In addition, the sliding part 200 is also divided into multiple sliding portions 200a along the circumferential direction around the axis of the rack bush 10; and thus the multiple sliding portions 200a are provided along the circumferential direction, and the sliding portions 200a are formed to have an arc-shaped cross-section.

In particular, the elastic rib 300 is connected to the mounting portion 100a; the elastic rib 300 is connected to an adjacent sliding portion 200a; and the sliding portion 200a is connected to another adjacent mounting portion 100a through another elastic rib 300.

Through this connection method, the mounting portions 100a and the sliding portions 200a are continuously joined and connected by means of the elastic rib 300, such that the force transmitted from the rack bar 30 may be more stably distributed and absorbed.

In an exemplary embodiment, in the present disclosure, one mounting portion 100a and one sliding portion 200a may face a plurality of sliding portions 200a and mounting portions 100a, respectively, in a divided configuration; and the elastic rib 300 may be connected between an end of the mounting portion 100a and an end of the sliding portion 200a facing the mounting portion 100a.

Referring to FIG. 3, the mounting portion 100a and the sliding portion 200a are arranged in a configuration in which the mounting portion 100a and the sliding portion 200a are rotated relative to each other by a predetermined angle around the axis of the rack bush 10.

Accordingly, a middle portion of the mounting portion 100a is positioned in an outer radial direction between two adjacent sliding portions 200a, such that one mounting portion 100a faces two sliding portions 200a.

In addition, a middle portion of the sliding portion 200a is positioned in an inner radial direction between two adjacent mounting portions 100a, such that one sliding portion 200a faces two mounting portions 100a. Accordingly, the sliding portions 200a and the mounting portions 100a are sequentially arranged along the circumferential direction.

In addition, with respect to FIG. 3, the elastic rib 300 is connected between a clockwise-side end of the sliding portion 200a and a counterclockwise-side end of the mounting portion 100a facing the clockwise-side end of the sliding portion 200a, and the elastic rib 300 is connected between a counterclockwise-side of the sliding portion 200a and a clockwise-side end of the mounting portion 100a facing the counterclockwise-side of the sliding portion 200a.

Accordingly, the mounting portions 100a and the sliding portions 200a may be continuously joined by the elastic rib 300 without interruption.

In addition, in the present disclosure, the mounting part 100 and the sliding part 200 may be formed on a concentric circle and equally divided into a plurality of portions; and the elastic ribs 300 may be disposed at equal or unequal angular intervals around the axis of the concentric circle.

For example, the axis center of the mounting part 100 and the axis center of the sliding part 200 may be coaxially formed, and the mounting part 100 and the sliding part 200 may each be divided into six portions with the mounting portions 100a and the sliding portions 200a disposed at equal angular intervals.

In addition, the elastic ribs 300 are disposed at equal angular intervals around the axis of the rack bush 10, such that the force applied from the rack bar 30 to the sliding portions 200a may be stably distributed.

In addition, in the present disclosure, a groove 210 may be formed along a circumferential direction on an inner

### Surface of the Sliding Portion 200a.

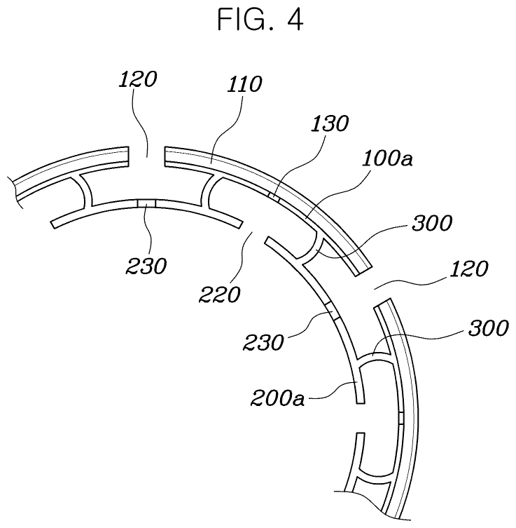

Referring to FIGS. 3 and 4, multiple grooves 210 having a groove shape are formed on an inner peripheral surface of each of the sliding portions 200a.

Accordingly, by storing and applying grease within the groove 210, frictional resistance generated by the sliding movement of the rack bar 30 is reduced, thereby enabling smooth movement of the rack bar 30.

In addition, the groove 210 may be formed to extend to ends of the sliding portion 200a in a circumferential direction.

That is, both ends of the groove 210 may be formed to be open at ends of the sliding portion 200a, thereby enabling smoother application of the grease stored within the groove 210.

In addition, an inner slot 220 having an axially cut shape may be formed between the sliding portion 200a and an adjacent sliding portion 200a adjacent to the sliding portion 200a.

As illustrated in FIGS. 2 and 3, the inner slot 220 is a gap portion formed in a thin, long groove shape between the sliding portions 200a due to the division of the sliding part 200.

Accordingly, the inner slot 220 is utilized as a passage for grease, such that the grease moves smoothly through the inner slot 220, thereby reducing frictional resistance generated by the sliding movement of the rack bar 30.

In addition, the inner slot 220 serves as an air pocket, such that when the elastic rib 300 is elastically deformed by the force applied from the rack bar 30, the sliding portion 200a also moves into the inner slot 220 and is elastically deformed, thereby stably supporting the rack bar 30.

Furthermore, in the present disclosure, an inner auxiliary slot 230 having an axially cut shape may be partially formed in a middle portion of the sliding portion 200a.

For example, the inner auxiliary slot 230 is a gap portion formed in a relatively short, straight line shape in the middle portion of the sliding portion 200a in one axial direction and the other axial direction of the sliding portion 200a.

Accordingly, the inner auxiliary slot 230, like the inner slot 220 described above, is utilized as a passage for grease, such that the grease moves smoothly through the inner auxiliary slot 230, thereby reducing frictional resistance generated by the sliding movement of the rack bar 30.

In addition, the inner auxiliary slot 230 serves as an air pocket, such that when the elastic rib 300 is elastically deformed by the force applied from the rack bar 30, a portion of the sliding portion 200a surrounding the inner auxiliary slot 230 flexibly moves into the inner auxiliary slot 230 and is elastically deformed, thereby more stably supporting the rack bar 30.

In addition, in present disclosure, an outer slot 120 having an axially cut shape may be formed between the mounting portion 100a and an adjacent mounting portion 100a adjacent to the mounting portion 100a.

As illustrated in FIGS. 2 and 3, the outer slot 120 is a gap portion formed in a slot shape between the mounting portions 100a due to the division of the mounting part 100.

Accordingly, the outer slot 120 is utilized as a passage for grease, such that the grease moves smoothly through the outer slot 120, thereby reducing frictional resistance generated by the sliding movement of the rack bar 30.

In addition, the outer slot 120 serves as an air pocket, such that when the elastic rib 300 is elastically deformed by the force applied from the rack bar 30, the mounting portion 100a also moves into the outer slot 120 and is elastically deformed, thereby stably mounting the rack bush 10 on the rack housing 20.

In addition, an outer auxiliary slot 130 having an axially cut shape may be partially formed in a middle portion of the mounting portion 100a.

For example, the outer auxiliary slot 130 is a gap portion formed in a relatively short, straight line shape in the middle portion of the mounting portion 100a in one axial direction and the other axial direction of the mounting portion 100a.

Accordingly, the outer auxiliary slot 130, like the outer slot 120 described above, is utilized as a passage for grease, such that the grease moves smoothly through the outer auxiliary slot 130, thereby reducing frictional resistance generated by the sliding movement of the rack bar 30.

In addition, the outer auxiliary slot 130 serves as an air pocket, such that when the elastic rib 300 is elastically deformed by the force applied from the rack bar 30, a portion of the mounting portion 100a surrounding the outer auxiliary slot 130 flexibly moves into the outer auxiliary slot 130 and is elastically deformed, thereby more stably mounting the rack bush 10 on the rack housing 20.

In addition, in the present disclosure, an assembly protrusion 110 may be formed to protrude from an outer surface of the mounting portion 100a.

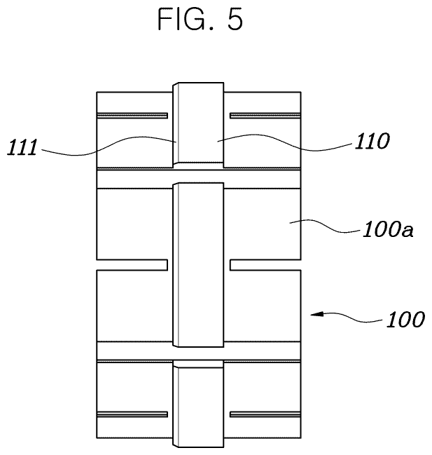

For example, as shown in FIGS. 2 and 5, the assembly protrusion 110 is formed to protrude from a middle portion of an outer peripheral surface of the mounting portion 100a along a circumferential direction.

In addition, although not illustrated in the drawings, a groove corresponding to the assembly protrusion 110 may be formed on an inner surface of the rack housing 20, such that the assembly protrusion 110 may be assembled into the groove formed on the inner surface of the rack housing 20.

In the present disclosure, the assembly protrusion 110 is described and illustrated as being formed in the middle portion of the mounting portion 100a, but the position at which the assembly protrusion 110 is formed along the axial direction of the rack bush 10 may vary, and the number of the assembly protrusions 110 may also vary.

In addition, a chamfer 111 may be formed at an axial end of the assembly protrusion 110.

That is, when the rack bush 10 is assembled into the rack housing 20, a portion where the chamfer 111 is formed is inserted and assembled into the rack housing 20, thereby enhancing the assemblability of the rack bush 10.

In addition, in the present disclosure, the elastic rib 300 may be formed to have a curved cross-sectional shape and to be bendable.

For example, an inner end of the elastic rib 300 is secured to an outer surface of the sliding portion 200a; an outer end of the elastic rib 300 is secured to an inner surface of the mounting portion 100a; and an middle portion between the inner end and the outer end is formed in an arc shape.

Accordingly, when the force of the rack bar 30 is applied to the sliding part 200, the middle portion of the elastic rib 300 may be easily bent and elastically deformed, thereby stably supporting the rack bar 30.

In addition, since the elastic rib 300 is formed in a curved shape, it is easy to modify the shape and size of the curve.

### Accordingly, When a Gap Occurs Between the Rack

housing 20 and the rack bush 10 due to a thickness dimensional tolerance of the rack bush 10, a radial dimension may be controlled by modifying the shape of the elastic rib 300, thereby enabling easy tuning in the event of a clearance or friction issue.

For reference, in addition to the curved cross-sectional shape, the shape of the elastic rib 300 may be modified to another shape capable of providing elasticity.

As described above, the present disclosure provides a structure that has an elastic and flexible deformation function through the elasticity of the elastic rib 300 and the slot structure, and stably supports the general movement of the rack bar 30 while effectively absorbing bending and twisting of the rack bar 30 when an external force is applied, thereby enabling smooth operation of the rack bar 30.

Furthermore, since the rack bush 10 is elastically deformed by the elastic rib 300 and the slot structure, additional assembly of an O-ring or the like required for elastic deformation of the rack bush 10 is unnecessary. Accordingly, the manufacturing process of the rack bush 10 may be simplified, thereby reducing the cost of the rack bush 10.

Although certain embodiments of the present disclosure have been illustrated and described, it will be apparent to those skilled in the art that various modifications and changes to the present disclosure may be made without departing from the technical spirit of the present disclosure provided in the following claims.

What is claimed is:

1. A rack bush comprising:
a mounting part mounted to surround an inner surface of a rack housing;
a sliding part formed to surround an outer surface of a rack bar and spaced apart from the mounting part; and
an elastic rib connected between the mounting part and the sliding part and configured to be elastically deformed to distribute and absorb a force transmitted from the rack bar to the sliding part.

2. The rack bush of claim 1, wherein:
the mounting part and the sliding part are divided into mounting portions and sliding portions along a circumferential direction, respectively, and
the elastic rib is connected between each of the mounting portions and each of the sliding portions, such that the mounting portions and the sliding portions are configured to be continuously joined by the elastic rib without interruption.

3. The rack bush of claim 2, wherein:
one mounting portion and one sliding portion face a plurality of sliding portions and mounting portions, respectively, in a divided configuration, and
the elastic rib is connected between an end of the mounting portion and an end of the sliding portion facing the end of the mounting portion.

4. The rack bush of claim 1, wherein:
the mounting part and the sliding part are formed on a concentric circle and equally divided into a plurality of portions; and
the elastic ribs are disposed at equal or unequal angular intervals around an axis of the concentric circle.

5. The rack bush of claim 2, wherein a groove is formed along a circumferential direction on an inner surface of the sliding portion.

6. The rack bush of claim 5, wherein the groove is formed to extend to ends of the sliding portion in a circumferential direction.

7. The rack bush of claim 2, wherein an inner slot having an axially cut shape is formed between the sliding portion and an adjacent sliding portion adjacent to the sliding portion.

8. The rack bush of claim 2, wherein an inner auxiliary slot having an axially cut shape is partially formed in a middle portion of the sliding portion.

9. The rack bush of claim 2, wherein an outer slot having an axially cut shape is formed between the mounting portion and an adjacent mounting portion adjacent to the mounting portion.

10. The rack bush of claim 2, wherein an outer auxiliary slot having an axially cut shape is partially formed in a middle portion of the mounting portion.

11. The rack bush of claim 2, wherein an assembly protrusion is formed to protrude from an outer surface of the mounting portion.

12. The rack bush of claim 11, wherein a chamfer is formed at an axial end of the assembly protrusion.

13. The rack bush of claim 1, wherein the elastic rib is formed to have a curved cross-sectional shape and to be bendable.
